(19) United States
(12) Patent Application Publication
(10) Pub. No.: US 2010/0046165 A1
(43) Pub. Date: Feb. 25, 2010

(54) Multifunction pads for portable or notebook computers

(76) Inventor: Michael Budge, Los Angeles, CA (US)

Correspondence Address: WILLIAM W. HAEFLIGER, 201 S. LAKE AVE, SUITE 512, PASADENA, CA, 91101, US

(21) Appl. No.: 12/229,195

(22) Filed: Aug. 21, 2008

(51) Int. Cl. G06F 1/16

(52) U.S. Cl. 361/679.59

(57) ABSTRACT

In combination with a computer having a first section supporting a keyboard and a second section supporting a screen, the second section pivotally connected to pivot between upright raised position and a down pivoted position with the second section then overlying the first section and keyboard, the improvement comprising the first section having two laterally spaced upwardly facing surfaces offset from the keyboard, two flat support pads respectively attached to the two spaced surfaces, and openly spaced below the second section in down pivoted position thereof, the pads being relatively thin, the pads sized to comfortably support the computer user's wrists during stroking of the keyboard, when the second section is in raised position, the screen located in a re-entrant recess formed by the second section, the pads received in said recess, but spaced from the screen in said second section down-pivoted position, the pads consisting of molded plastic material, there being auxiliary graphics on the pads and openly presented toward the screen, to be upwardly visible when the first section is raised relative to the second section.

### BACKGROUND OF THE INVENTION

This invention relates generally to enhancement of functioning of computers such as a portable laptop type computers; and more particularly to provision of a hand, wrist or palm support pad or pads which are positioned to extend directly beneath the normal position of the hands, wrists or palms of the operator of the computer, to provide a quasi normal feel of the solid surface computer, yet also provide lateral support for comfort, and protect against static electricity build-up, and heat expulsion from the computer body in contact with the user's hand or hands, as well as providing for information visual discernment.

The use of and advantages associated with portable computers are well known in the art. There has been an intense effort in the computer industry to down size the personal computer to provide users with a powerful yet portable computer that can be taken out of the office and fully utilized at home or on the road. As advancements have been made in both microprocessing chip and battery technologies, personal computers were eventually downsized into “laptop computers”.

While such computers offered the portability and processing power of a full sized personal computer, the laptop was still somewhat large and heavy for the user to carry around. In response to these disadvantages, the laptops were downsized even further into what is now commonly known in the industry as a notebook computer, which is smaller and more light weight yet possessing equal or greater processing capabilities than their earlier laptop counterpart.

Because of their portability, notebook computers are frequently used in many applications for many different forms of industry and commerce. Due to their increased power and processing capabilities, these machines operate with greater levels of static electricity and heat expulsion. These products of this modern technology can cause discomfort to the user at any given time. If an operator uses a notebook or portable computer for an extended period of time, he or she may experience hand discomfort and particularly the palms of the hands from such residual “waste” products, as well s need for directional support. Therefore, need exists to develop a more effective means to counteract these adverse affects. Also, a need exists for auxiliary information in visible graphics form, with changeability, and storage at the computer keyboard surface, and during its operation.

### SUMMARY OF THE INVENTION

It is a major object of the invention to provide improved information storage pads positioned and individually adjusted on a computer and configured to alleviate or eliminate the problems referred to. Basically, the invention provides for a combination that includes a computer having a first section supporting a keyboard and a second section supporting a screen, the second section pivotally connected to pivot between upright raised position, and a down pivoted position with the second section then overlying the first section and keyboard, the improvement comprising

a) the first section having two laterally spaced upward facing surfaces offset from the keyboard,

b) flat support pads respectively attached to said two spaced surfaces, and openly spaced below the second section in down pivoted position, thereof,

c) each pad being relatively thin,

d) each pad sized to comfortable support the computer user's wrist downwardly and laterally, during stroking of the keyboard, when the second section is in raised position,

e) the screen located in a re-entrant recess formed by the second section, the pad received in said recess, but spaced from the screen in said second section down-pivoted position,

f) the pad consisting of molded plastic material,

g) there being auxiliary graphics on the pad and openly presented toward the screen to be upwardly visible when the first section is raised relative to the second section.

As will be seen, the pads may have thickness less than about 0.010 inch, allowing pad reception into the re-entrant recess without engagement with the screen. In this regard, the computer sections may have interengagable stop shoulders proximate said recess to limit closing of second section downwardly toward the first section when said pads are in said recess. The pads may have press-on adhesive at their undersides, allowing press-on attachment to the lower section, and optional removal of the pad or pads, as desired, as for replacement by other similar pads, bearing other graphics, and or support configuration.

Another object includes providing for substantially rectangular pad dimensioning between about 8 and 9 centimeters, and overall width dimension between about 5 and 6 centimeters.

A further object includes providing each pad to have press-on adhesive material at its underside allowing ease of removal and replacement of the pad relative to said housing surface.

The method of pad use includes:
i) applying the pad to said surface by press-down force exertion on the pad,
ii) viewing the pad graphics in association with use of the computer,
iii) pull-off removal of the pad from said surface,
iv) and applying an auxiliary and like pad to said surface by press-on force exertion on that pad.

Another object includes provision of pad localized surface roughness extending lengthwise and widthwise of the pad periphery to block user's wrist slippage off the pad smooth surface.

This invention improves over that of U.S. Pat. No. 6,237,879.

These and other objects and advantages of the invention, as well as the details of an illustrative embodiment, will be more fully understood from the following specification and drawing, in which:

### DRAWING DESCRIPTION

FIG. 1 is a plan view of a preferred pad in accordance with the invention;

FIG. 2 is a perspective view of a laptop type computer, to which pads have been selectively applied;

FIG. 3 is an enlarged elevation taken in section to show positioning of components; and

FIG. 4 is a section taken on lines 4-4 of FIG. 3; and

FIG. 5 is a section showing pad carriage by the computer.

### DETAILED DESCRIPTION

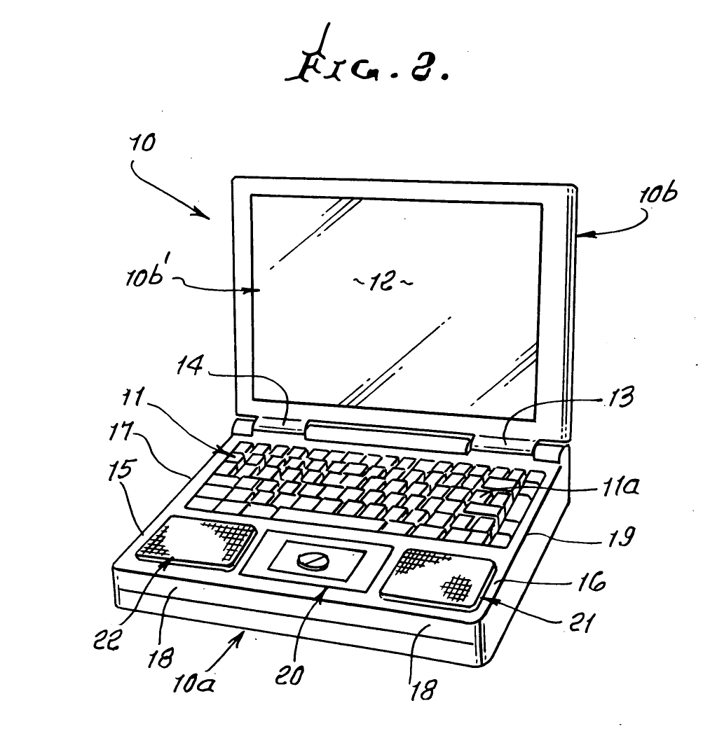

As shown in FIGS. 2 and 3, a laptop computer 10 has a first or lower section 10a supporting a keyboard 11 having multiple keys 11a, as is known. A second or upper section or monitor 10b supports or carries a screen or display zone 12. The second section is pivotally connected to the first section, as at horizontal pivot locations 13 and 14, to pivot between upright raised position 10b′ seen in FIG. 2, and a down pivoted or closed (stored) position indicated in FIG. 3. In that position, section 10b overlies the first section 10a and the tops of the keys 11a.

It will be noted in FIG. 2 that the first or base section 10a has two laterally spaced upward facing surfaces 15 and 16. Surface 15 is located laterally and rightwardly inwardly from the left end 17 of the section 10a, and longitudinally and forwardly inwardly from the front end 18 of the section 10a. Likewise, surface 16 is located laterally and leftwardly inwardly from the right end 19 of section 10a, and longitudinally forwardly and inwardly from the front end 18 of section 10a. There is a computer control region 20 between surfaces 15 and 16, and separating those surfaces. During manual stroking of the keys 11a, the user's left hand or wrist overlies region 15, and the user's right hand 18 wrist overlies region 16. Surfaces 15 and 16 are also rearwardly offset from the keyboard.

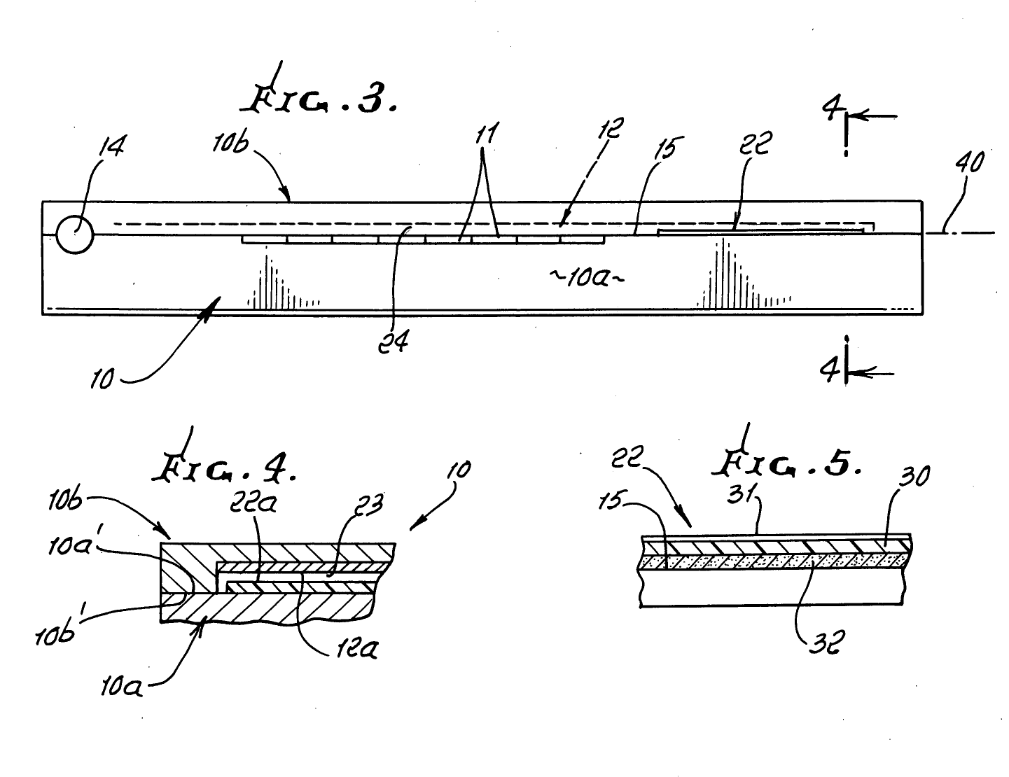

In accordance with the invention, two flat support pads 21 and 22 are respectively attached, for example removably adhered, to the two spaced surfaces 15 and 16, in selected adjusted positions, and in such manner that the pads are openly but closely spaced below the screen 12 in second section 10b in its down position, as is clear from FIGS. 3 and 4. See space 23 between the top level 22a of a pad 22 and the downfacing display side 12a of the screen in down position 12a of the screen 12. Note also greater space 24 between 12 and top level of the keyboard keys, in FIG. 3. Those keys are typically recessed below the top level 10a′ of section 10a. Rim 10b′ of section 10b seats on 10a′ as seen in FIG. 4.

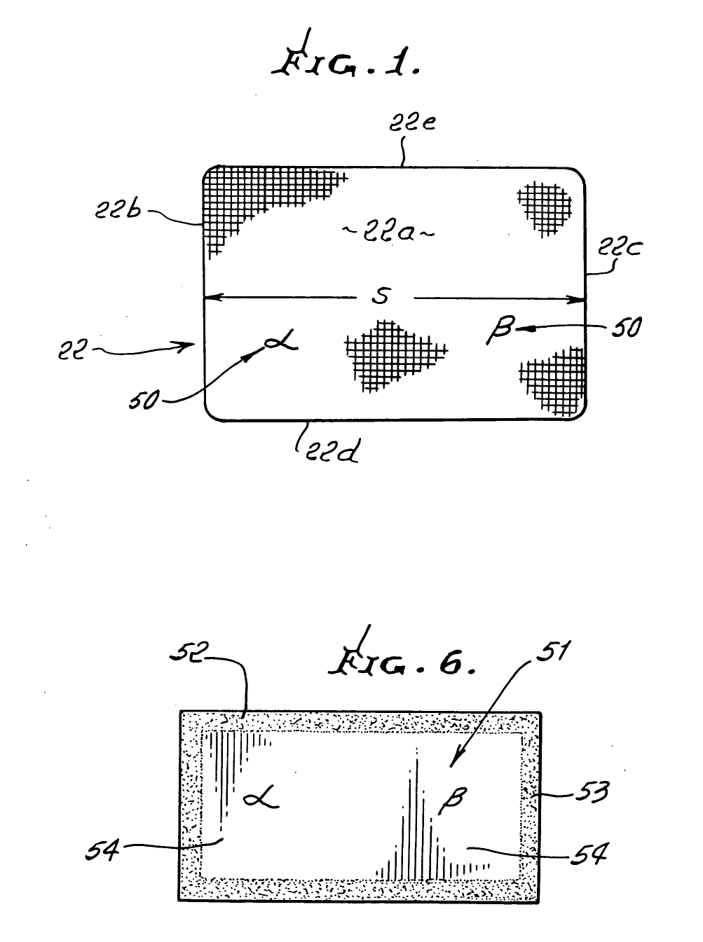

The two pads 21 and 22 each consist essentially of molded plastic material, and are thin. The pads have overall thickness less than about 0.010 inch, throughout the area of each pad, in order to provide the close gap or space 23 referred to, and also to provide support, for the user's hand or wrist undersides, during key stroking use of the computer, over extended time periods. Also, each pad has a looping edge, which bounds the pad area. In the example shown in FIG. 1, the pad 22 is generally rectangular, and has two laterally spaced edges 22b and 22c each of about 5-6 centimeters, and two longitudinally spaced edges 22d and 22e each of about 8-9 centimeters.

For best results, each pad preferably consists of:
i) an intermediate layer 30 of molded sheet plastic material,
ii) an upper layer 31 attached to the intermediate layer, the upper layer having less than half the thickness of the intermediate layer, and providing a graphics support,
iii) an under layer 32 of adhesive material removably adhesively attaching the pad to one of the base section upward facing surfaces. See FIG. 5.

Layers 31 and 32 are each substantially thinner than intermediate layer 30, to maximize wrist support provided by the overall thin pad. Upper surface of layer 31 is relatively smooth to facilitate wrist shifting while pad supported. Lower adhesive layer 31 preferably removably but firmly attaches the pad 22 to surface 16. Each pad has capability for forcible peel-off, in order to re-adjust the pad position on surface 16, i.e. closer to or further from each of edges 18 and 19. Such adjustability enables optimum pad positioning relative to the user's overlying wrist position, for addressing the keyboard.

Removability of the pads enables their replacement by other pads, with other graphics support, as at 31. The surface of 31 typically allows for graphics application, as by printing or writing on 31. One example is advertising graphics, which can be altered as by pad removal, and replacement by another pad. See representation graphics 50 in FIG. 1.

The method includes the steps:
i) applying the pad to said surface by press-on force exertion on the pad,
v) viewing the pad graphics in association with use of the computer,
vi) pull-up removal of the pad from said surface,
vii) and applying an auxiliary and like pad to said surface by press-on force exertion on that pad.

For compactness, the under-surfaces of the pads are typically in a plane 40 defined by the top surface of the keys recessed in space 42 typically defined by 10a.

FIG. 6 shows a modified pad top surface 51, locally coarsened, as at its periphery (see surface roughness along peripheral length and width edge stretches 52 and 53) to provide lateral support against wrist slippage on or off the pad central surface smooth region 54. Light knurling is an example.

I claim:

1. In combination with a computer having a first section supporting a keyboard and a second section supporting a screen, the second section pivotally connected to pivot between upright raised position and a down pivoted position with the second section then overlying the first section and keyboard, the improvement comprising
a) the first section having two laterally spaced upwardly facing surfaces offset from the keyboard,
b) two flat support pads respectively attached to said two spaced surfaces, and openly spaced below the second section in down pivoted position thereof,
c) said pads being relatively thin,
d) said pads sized to comfortably support the computer user's wrists during stroking of the keyboard, when the second section is in raised position,
e) the screen located in a re-entrant recess formed by the second section, the pads received in said recess, but spaced from the screen in said second section down-pivoted position,
f) the pads consisting of molded plastic material,
g) there being auxiliary graphics on the pads and openly presented toward the screen, to be upwardly visible when the first section is raised relative to the second section.

2. The combination of claim 1 wherein each said pads have thickness less than about 0.010 inch.

3. The combination of claim 1 wherein the pads are adhesively attached to said surface.

4. The combination of claim 1 wherein each pad is substantially rectangular and has overall length dimension between about 8 and 9 centimeters, and overall width dimension between about 5 and 6 centimeters.

5. The combination of claim 1 wherein said computer sections have interengagable stop shoulders proximate said recess to limit closing of the second section downwardly toward the first section when said pads extend in said recess.

6. In combination of with a computer having a first section supporting a keyboard and a second section supporting a screen, the second section pivotally connected to pivot between upright raised position and a down pivoted position with the second section then overlying the first section and keyboard, the improvement comprising
a) the first section having a laterally extending upward facing surface offset from the keyboard,
b) a flat support pad attached to said surface, and openly spaced below the second section in down pivoted position, thereof,
c) said pad being relatively thin,
d) said pad sized to comfortably support the computer user's wrist during stroking of the keyboard, when the second section is in raised position,
e) the screen located in a re-entrant recess formed by the second section, the pad received in said recess, but spaced from the screen in said second section down-pivoted position,
f) the pad consisting of molded plastic material,
g) there being auxiliary graphics on the pad and openly presented toward the screen to be upwardly visible when the first section is raised relative to the second section.

7. The combination of claim 6 wherein the pad has thickness less than about 0.010 inch, throughout its lengthwise and widthwise extent.

8. The combination of claim 6 wherein the pad is adhesively attached to said surface.

9. The combination of claim 6 wherein the pad is substantially rectangular and has overall length dimension between about 8 and 9 centimeters, and overall width dimension between about 5 and 6 centimeters.

10. The combination of claim 6 wherein said computer sections have interengagable stop shoulders proximate said recess to limit closing of the second section downwardly toward the first section when said pad is in said recess.

11. The combination of claim 1 wherein the pads have press-on adhesive material at their undersides, allowing ease of removal and replacement of the pad or pads, relative to said surfaces or surface.

12. The combination of claim 6 wherein the pad has press-on adhesive material at its undersides allowing ease of removal and replacement of the pad relative to said surface

13. The method of using the computer and pad of claim 12 which include
i) applying the pad to said surface by press-on force exertion on the pad,
ii) viewing the pad graphics in association with use of the computer,
iii) pull-up removal of the pad from said surface,
iv) and applying an auxiliary and like pad to said surface by press-on force exertion on that pad.

14. The combination of claim 6, the pad having localized surface roughness.

15. The combination of claim 14 wherein said surface roughness blocks wrist slippage off the pad, and extends proximate the pad periphery, lengthwise and widthwise of the pad.

16. The combination of claim 15 wherein said roughness consists of knurling.
